(19) United States
(12) Patent Application Publication
(10) Pub. No.: US 2025/0331026 A1
(43) Pub. Date: Oct. 23, 2025

(54) BEAMFORMING INFORMATION SIGNALING FOR NETWORK-CONTROLLED REPEATERS

(71) Applicant: Apple Inc., Cupertino, CA (US)

(72) Inventors: Hong He, San Jose, CA (US); Dawei Zhang, Saratoga, CA (US); Chunxuan Ye, San Diego, CA (US); Seyed Ali Akbar Fakoorian, San Diego, CA (US); Oghenekome Oteri, San Diego, CA (US); Wei Zeng, Saratoga, CA (US); Haitong Sun, Saratoga, CA (US); Yushu Zhang, Beijing (CN); Jie Cui, San Jose, CA (US); Chunhai Yao, Beijing (CN)

(73) Assignee: Apple Inc., Cupertino, CA (US)

(21) Appl. No.: 18/860,620

(22) PCT Filed: Apr. 29, 2022
(86) PCT No.: PCT/CN2022/090703

§ 371 Date: Oct. 25, 2024

(51) Int. Cl. H04W 74/0833; H04W 8/24; H04W 84/04

(52) U.S. Cl. CPC H04W 74/0833; H04W 8/24; H04W 84/047

(57) ABSTRACT

The present application relates to devices and components including apparatus. systems, and methods for signaling directive beamforming information for network-controlled repeaters in wireless networks.

### BACKGROUND

Network coverage is a fundamental aspect of cellular network deployments. Mobile operators rely on different types of network nodes to offer blanket coverage in their deployments. Deployments of regular, full-stack cells is one option, but it may not always be possible or economically viable. As a result, new types of network nodes have been considered to increase mobile operators' flexibility for their network deployments.

### BRIEF DESCRIPTION OF THE DRAWINGS

FIG. 1 illustrates a network environment in accordance with some embodiments.

FIG. 2 illustrates a flow diagram illustrating repeater identification and capability signaling in accordance with some embodiments.

FIG. 3 illustrates another flow diagram illustrating repeater identification and capability signaling in accordance with some embodiments.

FIG. 4 illustrates another flow diagram illustrating repeater identification and capability signaling in accordance with some embodiments.

FIG. 5 illustrates a beam pattern in accordance with some embodiments.

FIG. 6 illustrates an activation pattern in accordance with some embodiments.

FIG. 7 illustrates an activation pattern in accordance with some embodiments.

FIG. 8 illustrates an activation pattern in accordance with some embodiments.

FIG. 9 illustrates transmission power signaling aspects in the network environment in accordance with some embodiments.

FIG. 10 illustrates further signaling aspects in the network environment in accordance with some embodiments.

FIG. 11 illustrates receive beam determination in accordance with some embodiments.

FIG. 12 illustrates beam information signaling in accordance with some embodiments.

FIG. 13 illustrates an operation flow/algorithmic structure in accordance with some embodiments.

FIG. 14 illustrates another operation flow/algorithmic structure in accordance with some embodiments.

FIG. 15 illustrates another operation flow/algorithmic structure in accordance with some embodiments.

FIG. 16 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

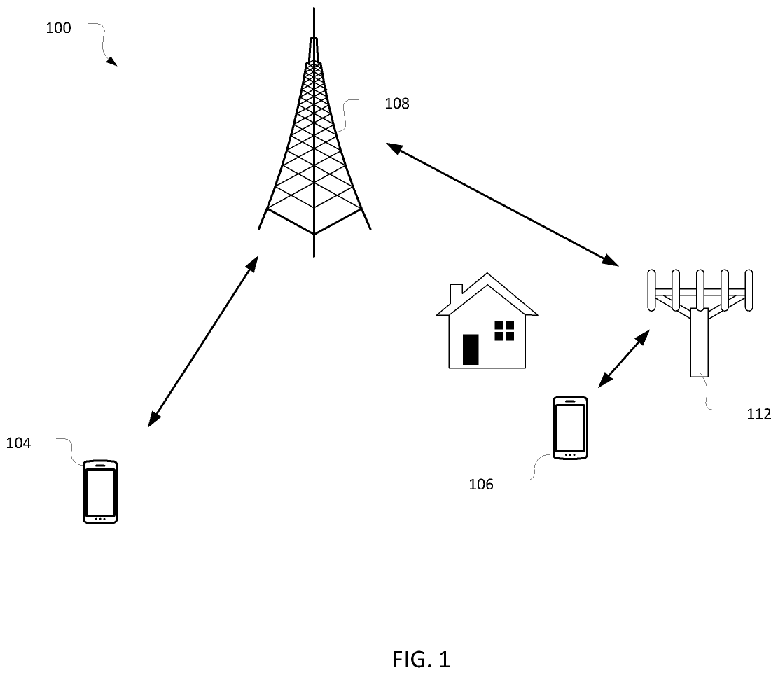

FIG. 1 illustrates a network environment 100 in accordance with some embodiments. The network environment 100 may include UE 104, UE 106, a base station 108, and a network-controlled (NC) repeater 112. The base station 108 may provide one or more wireless access cells, for example, NR cells, through which the UEs 104/106 may communicate with the base station 108. The UEs 104/106 and the base station 108 May communicate over air interfaces compatible with Fifth Generation (5G) NR system standards as provided by 3GPP technical specifications. The base station 104 may be a next generation node B (gNB) that provides one or more 5G NR cells to provide NR user plane and control plane protocol terminations toward the UEs 104/106.

The NC repeater 112 may be used by the base station 108 to improve coverage in specific areas. As shown, the NC repeater 112 may provide an interface for the UE 106, while the UE 104 communicates directly with the base station 108.

As used herein, a UE connected directly with the base station 108 may be referred to as a G-UE, and a UE connected with the NC-repeater 112 may be referred to as an R-UE. Signals forwarded by the NC-repeater 112 may also be referred to with the “R” prefix. For example, a synchronization signal physical broadcast channel block (SSB) transmitted by the NC-repeater 112 may be a R-SSB, a channel state information-reference signal (CSI-RS) transmitted by the NC-repeater 112 may be a R-CSI-RS, and a system information block type 1 (SIB1) transmitted by the NC-repeater 112 may be an R-SIB1. Signals transmitted by the base station 108 to G-UEs may be referred to with a “G” prefix (for example, G-SSB, G-CSI-RS, and G-SIB1).

Unlike a standard radio-frequency (RF) repeater, the NC repeater 112 may be capable of receiving and processing side control information from the base station 108. The side control information may allow the NC repeater 112 to perform its amplify-and-forward operation in a more efficient manner. The NC-repeater 112 may mitigate unnecessary noise amplification, improve spatial directivity of transmissions and receptions, and simplify network integration.

The side control information that may be transmitted to the NC repeater 112 may include beamforming information, timing information to align transmission or reception boundaries of the NC repeater 112, information on uplink (UL)-downlink (DL) time division duplexing (TDD) configuration, power control information for efficient interference management, and on/off information for efficient interference management and improved energy efficiency.

Embodiments of the present disclosure describe how the base station 108 may identify the NC repeater 112 and provide beamforming side control information for SSB sweeping and side control information related to a random access channel (RACH) procedure for the UE 106.

The UEs 104/106 and the NC repeater 112 may utilize random-access channel (RACH) procedures to access resources provided by the base station 108. In some embodiments, an accessing device (for example, UE 104, UE 106, or the NC repeater 112) may use a four-step RACH procedure or a two-step RACH procedure.

A four-step RACH procedure may be as follows. In a first step, the accessing device may randomly select a preamble from a pool of shared preambles and transmit the preamble to the base station 108 in a first message (Msg1). In a second step, the base station 108 may respond to the first message by transmitting a random-access response (RAR) in a second message (Msg 2). The RAR may include a random access preamble identifier, timing alignment information, initial uplink grant, and temporary C-RNTI (TC-RNTI). If the accessing device receives a PDCCH with the RAR within a defined time window, and the RAR includes a preamble identifier that corresponds to the preamble transmitted in Msg1, the response is successful. Then, in the third step, the accessing device may send a scheduled uplink transmission over a PUSCH in a third message (Msg3). The third message may include an ID for contention resolution. In the fourth step, the base station 108 may send the contention resolution ID in a fourth message (Msg4) that, if properly decoded by the accessing device, may complete the procedure.

A two-step RACH procedure may be as follows. In a first step, the accessing device may transmit a first message (MsgA) that includes a PRACH preamble transmission and a PUSCH transmission. Thus, MsgA represents a combination of Msg1 and Msg3 of the four-step procedure. In a second step, the base station 108 may respond with a second message (MsgB) that includes both random access response and contention resolution content. Thus, MsgB represents a combination of Msg2 and Msg4 of the four-step procedure.

In some embodiments, aspects of the RACH procedure between the base station 108 and the NC repeater 112 may be used to provide the base station 108 with information about an identity of the NC repeater 112.

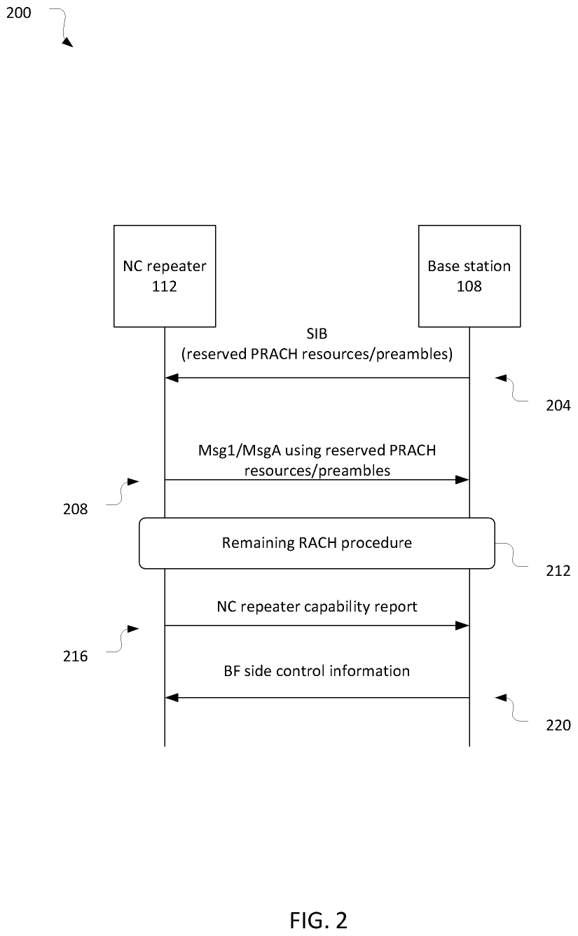

FIG. 2 is a flow diagram 200 illustrating repeater identification and capability signaling in accordance with some embodiments.

At 204, the flow diagram may include the base station 108 transmitting a system information block (SIB) to the NC repeater 112. The SIB, which may be a SIB type 1 (SIB1) or an NC-repeater-specific SIB, may include a set of dedicated PRACH resources or preambles that are reserved for use by NC repeaters, such as NC repeater 112. These PRACH resources/preambles may be configured by the SIB for identification of the NC repeater 112.

At 208, the NC repeater 112 may select a reserved PRACH resource for a Msg1 transmission or a reserved PRACH preamble for a MsgB transmission and transmit the Msg1/MsgB transmission. The base station 108 may detect the use of the dedicated PRACH resource/preamble and determine that an accessing device is an NC-repeater, rather than a standard UE.

At 212, the NC repeater 112 and the base station 108 may complete the remaining PRACH procedure to establish a connection.

At 216, the NC repeater 112 may transmit an NC-repeater capability report to the base station 108. The NC-repeater capability report may include capability information that may allow the base station 108 to appropriately configure the forward link provided by the NC repeater 112. The NC-repeater capability report may include information on antenna configurations and transmission power capabilities of the NC repeater.

The antenna configuration information may include: a number of antenna panels (Ng) on the NC repeater 112; a number of antenna elements in a vertical direction per panel (N1); a number of antenna elements in a horizontal direction per panel (N2); discrete

Fourier transform (DFT) oversampling in the horizontal direction per panel (O1); and DFT oversampling in the vertical direction per panel (O2).

In some embodiments, a plurality of sets of antenna configurations (e.g., Ng, N1, N2, O1, O2) may be predefined into, for example, a 3GPP Technical Specification (TS). In these embodiments, the NC repeater 112 may simply provide, in the NC repeater capability report, an index to the antenna configuration set that corresponds to capabilities of the NC repeater 112.

The base station 108 may use the information in the NC repeater capability report to derive a beamforming capability of the NC repeater 112. The base station 108 may then select beam direction for SSB-sweeping operation based on the beamforming capability. The base station 108 may generate beamforming (BF) side control information with an indication of the selected beam directions for SSB sweeping. The BF side control information may be provided to the NC repeater 112 at 220.

The BF side control information may be conveyed in various signaling/channels in accordance with different embodiments. For example, in a first option, the BF side control information may be transmitted to the NC repeater 112 using a dedicated DCI format over a PDCCH channel. In a second option, the BF side control information may be transmitted using higher layers. For example, the BF side control information may be transmitted using radio resource control (RRC) signaling or media access control (MAC) signaling (for example, a MAC control element or a MAC protocol data unit (PDU)). In some embodiments, higher-layer functionality may not be available on the NC repeater 112 in order to reduce complexity. In these embodiments, the lower-layer signaling may be relied upon to transmit the BF side control information.

While various embodiments describe configuration and performance of an SSB sweeping operation by the NC repeater 112, other embodiments may use similar concepts for configuration and performance of CSI-RS sweeping by the NC repeater 112.

In some embodiments, the NC repeater capability report may additionally/alternatively include a maximum transmission power (P_cmax,R) of the NC repeater 112. In some embodiments, a set of power classes may be predefined in, for example, a 3GPP TS, with each power class associated with a maximum output power. In these embodiments, the NC repeater 112 may simply provide, in the NC repeater capability report, an index to the power class that corresponds to a maximum output power of the NC repeater 112.

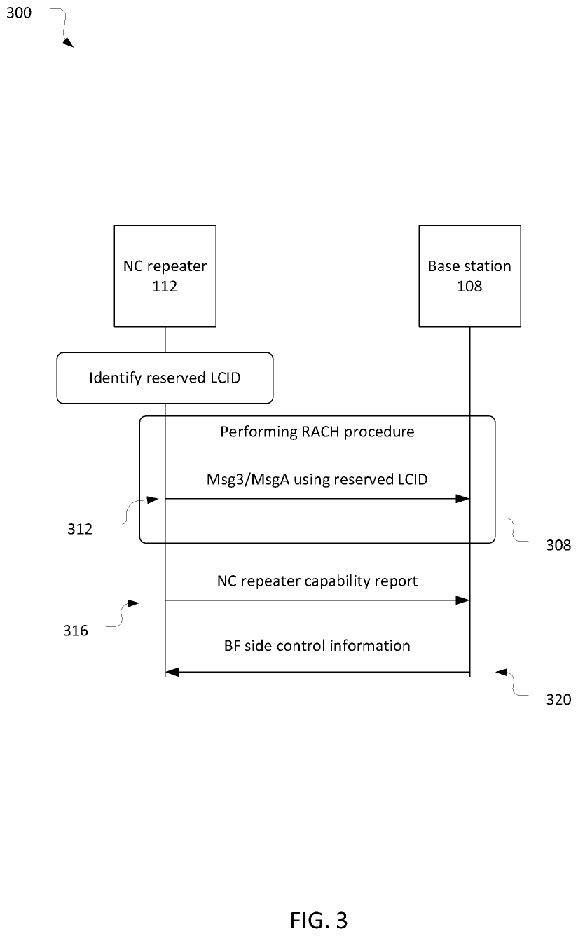

FIG. 3 is another flow diagram 300 illustrating repeater identification and capability signaling in accordance with some embodiments.

At 304, the flow diagram may include the NC repeater 112 identifying a dedicated logical channel identifier (LCID) In some embodiments, the dedicated LCID may be provided to the NC repeater 112 by the base station 108. In other embodiments, the dedicated LCID may be predefined in, for example, a 3rd Generation Partnership Project (3GPP) Technical Specification. The dedicated LCID may be reserved for use by NC repeaters, such as NC repeater 112.

At 308, the NC repeater 112 and the base station 108 may engage in a RACH procedure. The RACH procedure may be a 2-step procedure or a 4-step procedure.

At 312, the NC repeater may use the dedicated LCID in a Msg3 transmission of a 4-step RACH procedure or a MsgA PUSCH of a 2-step RACH procedure when the Msg3/MsgA PUSCH includes a common control channel (CCCH). The base station 108 may detect the LCID and determine that an accessing device is an NC-repeater, rather than a standard UE.

After the RACH procedure 308, the NC repeater 112 may transmit an NC repeater capability report at 316 and the base station 108 may transmit BF side control information at 320. Capability reporting and configuration of the BF side control information may be similar to that described above with respect to FIG. 2.

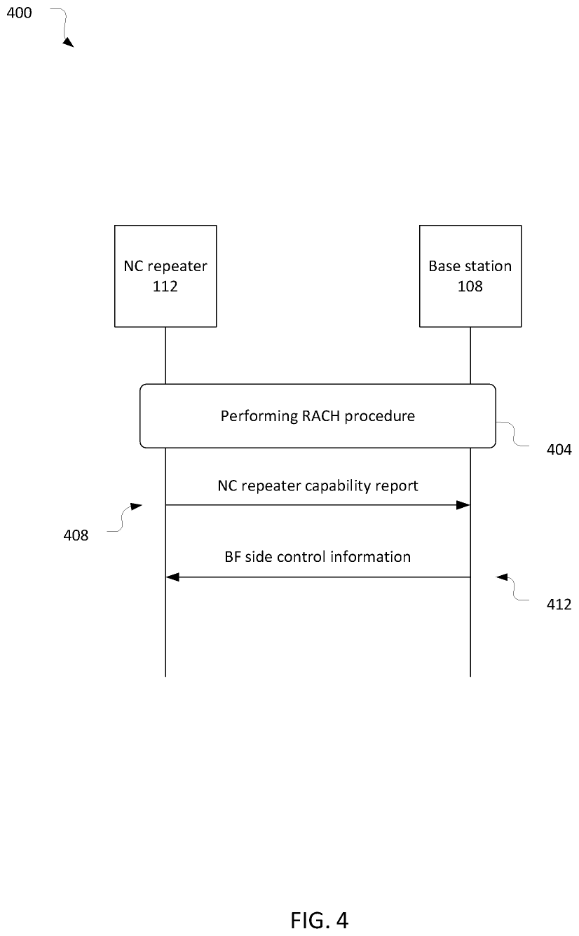

FIG. 4 is another flow diagram 400 illustrating repeater identification and capability signaling in accordance with some embodiments.

At 404, the NC repeater 112 and the base station 108 may engage in a RACH procedure. The RACH procedure may be a 2-step procedure or a 4-step procedure.

At 408, the NC repeater 112 may transmit an NC repeater capability report to the base station 108. Similar to that described above with respect to FIG. 2, the NC-repeater capability report may include information on antenna configurations and transmission power capabilities of the NC repeater 112. However, in this embodiment, the NC-capability report may additionally/alternatively include a device type information element (IE). The device type IE may provide the indication to the base station 108 that the NC repeater 112 has an NC-repeater device type, as opposed to a standard UE.

At 412, the base station 108 may transmit BF side control information. Configuration of the BF side control information may be similar to that described above with respect to FIG. 2.

In accordance with various aspects of this disclosure, the beam information for SSB sweeping at the NC repeater 112 may be provided in a number of different ways. In general, a beam pattern may be predetermined in, for example, a 3GPP specification, for each potential antenna layout configuration <N1, N2, O1, O2>.

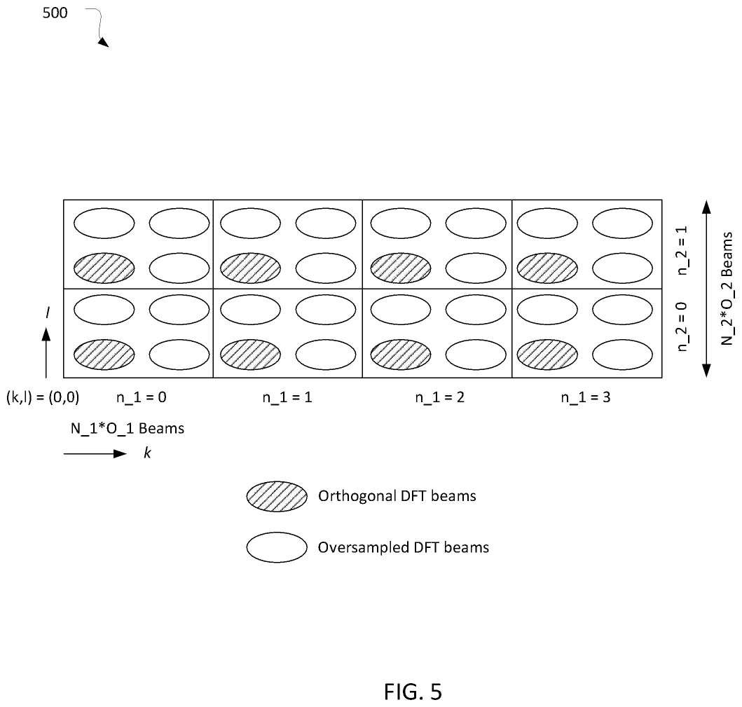

A discrete Fourier transform (DFT)-based codebook may be used to create a beamforming matrix to produce weights for M-beams that are uniformly spaced in a spatial domain, where M=N₁*O₁*N₂*O₂. FIG. 5. illustrates a beam pattern 500 corresponding to an antenna layout configuration <N1, N2, O1, O2>=<4, 2, 2, 2> in accordance with some embodiments.

The base station 108 may provide the NC repeater 112 with an indication of a beam direction that it is to use for an SSB sweeping operation using any of a number of options.

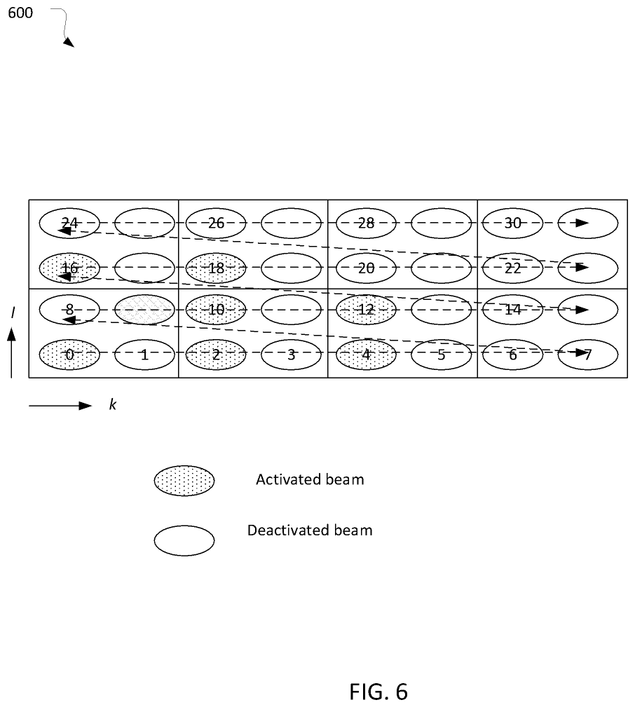

In a first option, the base station 108 may provide a bitmap-based beamforming indication. For example, each bit ‘i’ in the bitmap string may indicate an activation/deactivation status of a beam index ‘i,’ where the beam index is ordered first in ascending order in a horizontal direction and then in a vertical direction. FIG. 6 illustrates an activation pattern 600 with respect to the beam pattern 500 in accordance with some embodiments. The horizontal, then vertical order is illustrated by dotted lines.

A bitmap having bit ‘i’ set to 1 may indicate that an associated beam is selected for a beam sweep operation. The activated beams shown in the activation pattern 600 may be the result of the base station 108 transmitting bitmap string <10101000 01101000 10100000 00000000> to the NC repeater 112.

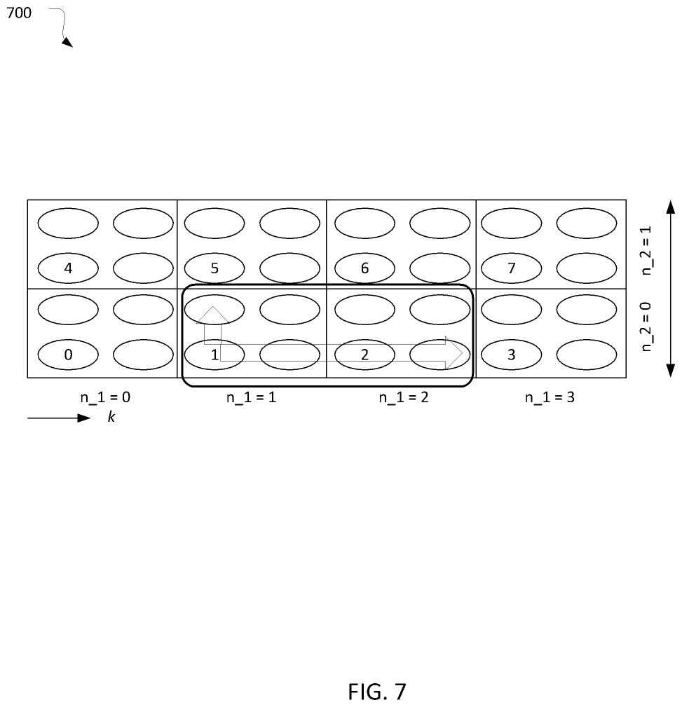

In a second option, the base station 108 may provide contiguous beam indication signaling. FIG. 7 illustrates an activation pattern 700 with respect to the beam pattern 500 in accordance with some embodiments. The activation pattern 700 may illustrate aspects of contiguous beam indication signaling.

Contiguous beam indication signaling may be performed in accordance with a first suboption or a second suboption.

In a first suboption, beamforming side control information may include a beam indication value that corresponds to a starting beam index, a number of contiguous beams in a horizontal direction, and a number of contiguous beams in a vertical direction.

In some embodiments, the starting beam may be limited to one of the orthogonal DFT beams of a particular antenna layout. The orthogonal DFT beams, which may be referred to as N_t, may be indexed in an order of horizontal first and vertical second as shown in FIG. 7. The starting beam index i, 0≤i≤Nₜ, may be indicated using [log₂(Nₜ)] bits. Three bits may be used to indicate the starting beam index in FIG. 7. As shown, the starting beam index may be <001> to indicate the starting beam index 1.

The number of contiguous beams in the horizontal direction, which may be referred to as L_h, may be indicated using [log₂(N₁*O₁)] bits. As shown, the L_h may be <100> to indicate an L_h of four.

The number of contiguous beams in the vertical direction, which may be referred to as L_v, may be indicated using [log₂(N₂ *O₂)] bits. As shown, the L_v may be <10> to indicate an L_v of two.

The second suboption of the contiguous beam signaling may include using a starting and length based approach. In this approach, the starting beam index may be jointly encoded with a first one of the L_h value or the L_v value and a second one of the L_h value or the L_v value may be signaled separately. For example, in a first alternative, the starting beam index and the L_h value may be jointly encoded using [log₂(N₁*O₁)*((N₁*O₁)+1)/2] bits and the L_v value is indicated using [log₂(N₂*O₂)] bits. In a second alternative, the starting beam index and the L_v value may be jointly encoded using [log₂(N₂*O₂)*(N₂*O₂+1)/2] bits and the L_h value is indicated using [log₂(N₂*O₂)] bits.

In some embodiments, the starting beam index may correspond to one of the orthogonal DFT beams. In other embodiments, the starting beam index may correspond to any of the beams.

Table 1 illustrates signaling overhead comparison of various embodiments of the contiguous beam indication signaling.

TABLE 1

| Signaling Approach | Number of Bits |
|---|---|
| Bitmap-based beamforming indication | 32 |
| Contiguous beam indication | 8 = (3 + 3 + 2) |
| (Suboption 1) | |
| Contiguous beam indication | 8 = (6 + 2) |
| (Suboption 2 - Alternative 1) | |
| Contiguous beam indication | 7 = (4 + 3) |
| (Suboption 2 - Alternative 2) | |

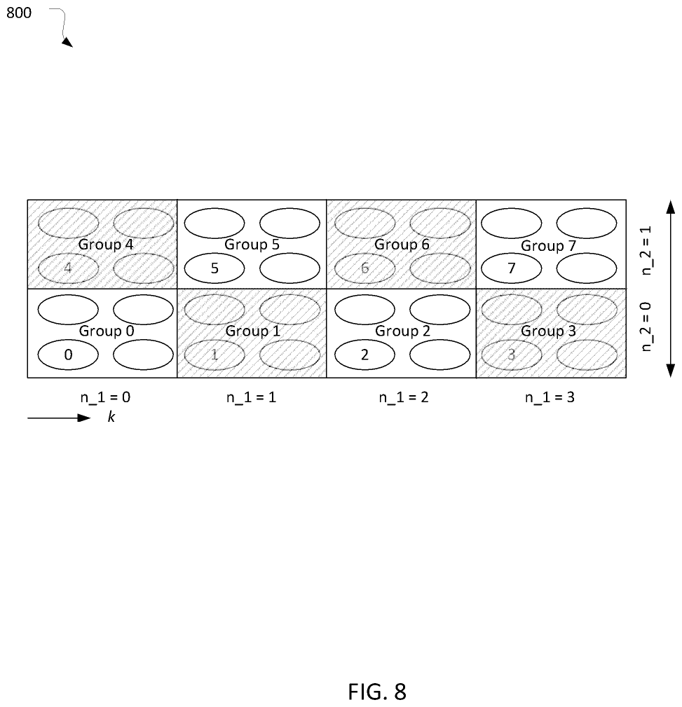

In some embodiments, a beam-group-based indication may be used for SSB sweeping operation. FIG. 8 illustrates an activation pattern 800 with respect to the beam pattern 500 in accordance with some embodiments. The activation pattern 800 may illustrate aspects of beam-group-based indication.

This embodiment, each orthogonal DFT beam may be grouped with a plurality of associated oversampling DFT beams to form a beam group. The beam groups may be indexed in the horizontal direction first, and the vertical direction second. As shown, the beams may be organized into eight groups, group 0-group 7.

A bitmap may then be used to indicate the beam group indices that are selected by the base station 108 for SSB sweeping at the NC repeater 112. A bit value of ‘1’ for a beam group index may indicate that all beams of the corresponding beam group are to be activated. The base station 108 may generate and signal a bitmap <01011010> to the beams of beam groups 1, 3, 4, and 6 as shown in the activation pattern 800.

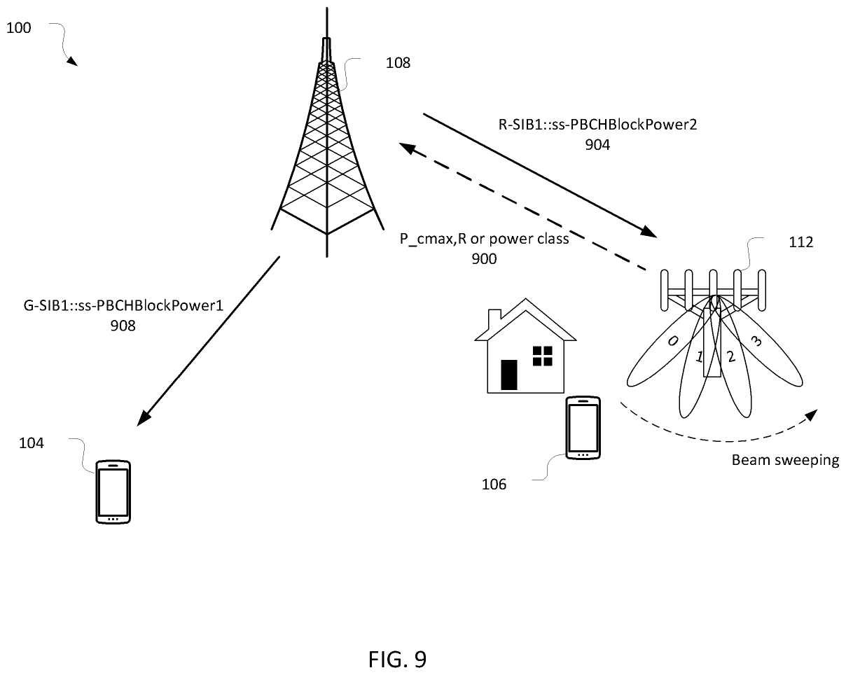

FIG. 9 illustrates transmission power signaling aspects in the network environment 100 in accordance with some embodiments.

SSB transmission power may be signaled in SIB1 information using an ss-PBCH-BlockPower IE. The SSB transmission power may be used by a UE to calculate downlink pathloss and determine the transmission power of an associated PRACH transmission. Various options may be used to signal transmission power of an R-SSB.

In a first option, the base station 108 may compute a transmission power for the R-SSB based on the maximum transmission power (P_cmax,R) or power class reported by the NC repeater 112 at 900. For example, the base station 108 may set the R-SSB transmission power, conveyed by ss-PBCHBlockPower2 in an R-SIB1 at 904, equal to the maximum transmission power. The NC repeater 112 may forward the R-SIB1 to the R-UE 106. The R-UE 106 may then calculate its downlink pathloss and determine its transmission power of an associated PRACH transmission based on the maximum transmission power (P_cmax,R). With this option, the NC repeater 112 may always use at least its maximum transmission power (P_cmax,R) for transmitting the R-SSB in the beam sweeping operation.

In some instances, the base station 108 may set an SSB transmission power, conveyed by ss-PBCHBlockPower1 in a SIB1 at 908, to another transmit power, for example, the maximum transmit power of the base station 108. Thus, in the first option, the SSB transmission power encoded in a SIB1 payload may vary across different downlink beams depending on whether the SIB1 is used as an R-SIB1 or not.

In a second option, the base station 108 may use a PRACH target reception power to account for differences in a maximum transmit power of the base station and the maximum transmit power of the NC repeater 112. The PRACH target reception power may be a metric that the base station 108 calculates and sends to a UE. The UE may use the PRACH target reception power, along with the SSB transmission power from ss-PBCH-BlockPower and a downlink pathloss estimated based on the SSB measurements, to calculate a transmission power the UE will use for a PRACH transmission.

In the second option, the base station 108 may calculate a difference, Δ, as follows: Δ=P_{cmax,gNB}−P_{cmax,R}, where P_{cmax,gNB} is the maximum power of the base station 108. The base station 108 may then determine the PRACH target reception power, T_R-UE, as follows: T_{R-UE}=T_{G-UE}−Δ, where T_G-UE, represents an indicated PRACH target power in a normal SIB1 for a UE that is directly connected with the base station 108, for example, UE 104.

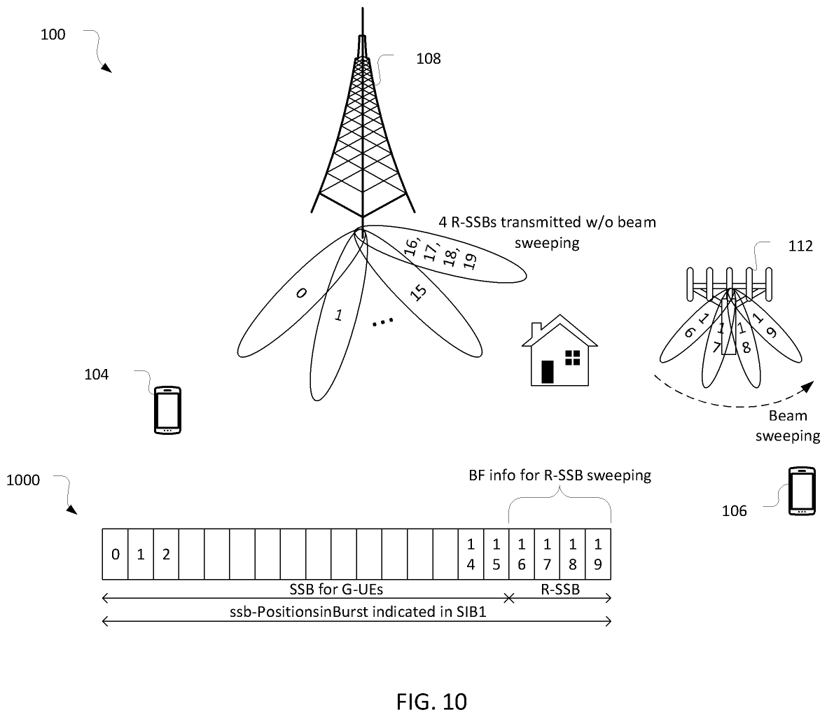

FIG. 10 illustrates R-SSB signaling aspects in the network environment 100 in accordance with some embodiments.

After the NC repeater 112 has gained initial access to, and been identified by, the base station 108, the base station 108 may provide the NC repeater 112 with R-SSB information. The R-SSB information may include an R-SSB periodicity and an R-SSBb-PositionsInBurst 1000.

The R-SSB periodicity may be the same or different from a G-SSB periodicity. For example, in some instances, to save power the R-SSB periodicity may be greater than the G-SSB periodicity. This may be justified as there may be fewer R-UEs than G-UEs.

The R-SSBb-PositionsInBurst 1000 may be an IE in the SIB1 used to indicate time-domain positions of the R-SSBs in a half frame on a Un link between the base station 108 and the NC repeater 112. In some embodiments, the number of R-SSBs may be the same as the number of sweeping beams indicated by the beamforming control information for the R-SSBs.

FIG. 10 illustrates the R-SSBb-PositionsInBurst 1000 providing a four R-SSB allocation, and further illustrates beam sweeping patterns by both the base station 108 and the NC repeater 112.

As shown, the base station 108 may transmit 20 SSBs. The first 16 SSBs, SSB index 0-SSB index 15, are transmitted by the base station 108 in a beam sweeping manner for G-UEs. The last four SSBs, SSB index 16-SSB index 19, are R-SSBs that the base station 108 transmits to the NC repeater 112 in a single beam. The NC repeater 112 may then transmit the four R-SSBs in a beam sweeping manner for R-UEs.

The base station 108 may provide the NC repeater 112 with the indication to use the subset of the SSB burst (for example, SSBs 16-19) as R-SSBs for the forwarding link in a number of manners. In some embodiments, the indication may be provided by dedicated signaling (RRC/MAC-CE/DCI) after the NC-repeater 112 is explicitly identified by the network.

In some embodiments, the NC repeater 112 may be provided with information related to beam sweeping for receiving RACH signals. Various approaches may be used to indicate the time-domain pattern of reception beams at the NC repeater 112 for signals in a RACH procedure including, for example, PRACH/Msg3 reception and Msg2/Msg4 transmission.

A beam indication for Msg1 or MsgA preamble reception may be provided in accordance with one or more of the following alternatives.

In a first alternative, the PRACH time-domain pattern parameter ‘prach-ConfigurationIndex’ may be provided to the NC repeater 112. The NC repeater 112 may then derive the RACH occasion (RO) time domain location for each R-SSB based on the ‘prach-Configuration Index.’ The NC repeater 112 may then identify beamforming information of an R-SSB by referencing a stored table based on the prach-ConfigurationIndex. The stored table may be similar to table 6.3.3.2-2 of 3GPP TS 38.211 v17.1.0 (2022-04-01). The NC repeater 112 may then select a receive beam based on the indicated beamforming information for PRACH reception.

In a second alternative, the NC repeater 112 may not be required to independently derive the beamforming information for PRACH reception based on the R-SSB. Instead, the corresponding beamforming information for each time-domain RO may be determined by the NC repeater 112 as follows.

The base station 108 may provide time-domain location of PRACH resources based on one or more of the following options.

In a first option, the base station 108 may provide the prach-ConfigurationIndex to the NC repeater 112. This option may be similar to the first alternative in terms of providing the PRACH resource configuration in time domain. However, in the first alternative, the NC repeater 112 may derive the reception beams for the RRC-configured PRACH resources based on the R-SSB and its association with PRACH resources, as explained above. While, in the first option of the second alternative, as elaborated in the following paragraph, the Rx beam of PRACH resource is derived by UE based on the total number of R-SSBs allocated to NC Repeater 112 by the base station 108.

In a second option, the base station 108 may explicitly provide the time domain location of the PRACH resources in an NC repeater configuration. This information may include a periodicity, a subframe index, a starting symbol index, a number of PRACH slots within a subframe and a number of time-domain ROs within a PRACH slot, and a PRACH duration/format.

Beamforming information for PRACH reception may be determined by first ordering ROs in a time domain in increasing order of RO time resource indexes in symbols and slots. Second, the ‘K’ indicated beams may be sequentially mapped to the first ‘K’ ordered ROs. The same beam mapping pattern may continue to the remaining ROs within the period.

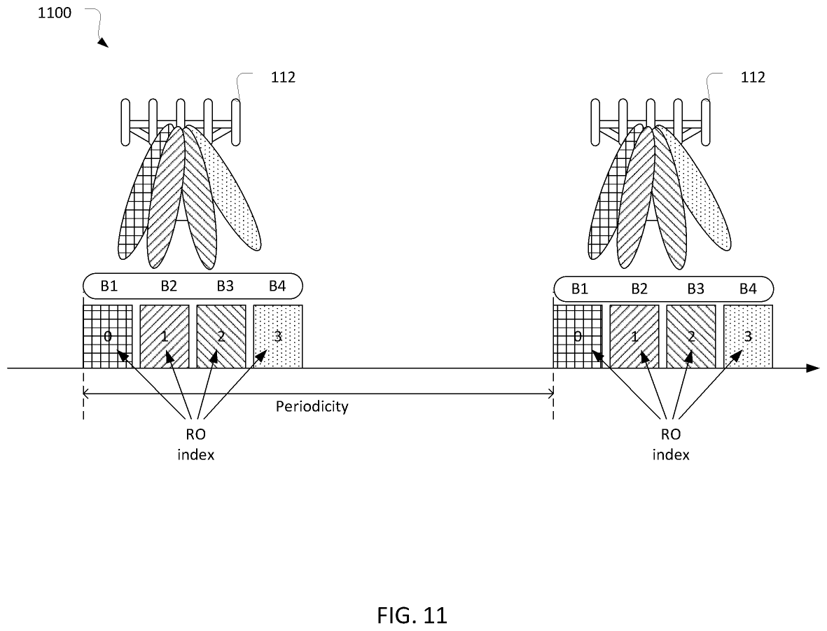

FIG. 11 illustrates a receive beam determination 1100 for PRACH reception in accordance with some embodiments. The receive beam determination 1100 may represent an implicit receive beam determination for PRACH reception based on beams indicated for R-SSB sweeping. This may correspond to the second option for providing time-domain location of PRACH resources discussed above.

For receive beam determination 1100, four beams, B1-B4, may be configured for R-SSB sweeping. The NC repeater 112 may implicitly associate assigned beams with four time-domain ROs, for example, RO indexes 0-3, in a period. Thus, if the NC repeater 112 receives a PRACH transmission in the RO with index 0, it may use B1 as the receive beam.

Unlike PRACH resources, the Msg2 RAR and Msg4 PDSCH may be dynamically scheduled by PDCCH for R-UEs. In some designs, a new DCI format X may be used to indicate transmit/receive beams that the NC repeater 112 is to use for Msg2, Msg3, or Msg4 and other messages except the PRACH message.

In some instances, a TDD UL/DL configuration pattern may be provided to the NC repeater 112. The NC repeater 112 may additionally be semi-statically configured with further parameters that may be used to indicate time-domain beam patterns for transmission or reception. These further parameters may include a beam indication periodicity and a duration.

A beam indication periodicity may be provided as a number, P, of slots. In some embodiments, P=1 or 2 slots.

The duration may be provided as a number, Z, of symbols for each beam index indicated by DCI Format X. The value of Z may be configured by the base station 108 for the repeater 112. Considerations of trade-offs between beam adaptation rate and signaling overhead may be considered into the configuration of Z. In some embodiments, Z=1, 2, or 7 symbols.

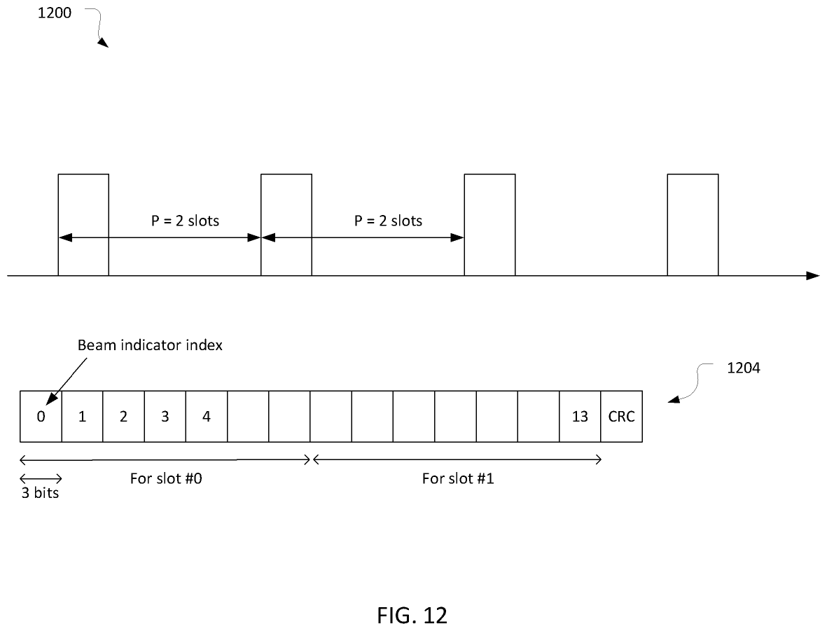

FIG. 12 describes beam information signaling 1200 in accordance with some embodiments. The base station 108 may transmit the beam information to the NC repeater 112 using DCI Format X 1204 with a cyclic redundancy check (CRC) scrambled with a dedicated radio network temporary identity (RNTI) such as, for example, a beam indicator RNTI (BI-RNTI).

The beam information may include N beam indicators, for example beam indicator 1, beam indicator 2, beam indicator 3, . . . , beam indicator N. Each beam indicator (BI) field may include [log₂(Bₜₒₜ+1)], where B_tot is a total number of beams configured by the base station 108 for the NC repeater 112.

Table 2 illustrates BI field definitions in an embodiment in which four beams are configured for the NC repeater 112 (for example, B_tot=4), which results in each BI field including [log₂(5)]=3 bits.

TABLE 2

| Value of BI field | Beam index |
|---|---|
| ‘000’ | Unknown |
| ‘001’ | B1 |
| ‘010’ | B2 |
| ‘011’ | B3 |
| ‘100’ | B4 |
| ‘101’-‘111’ | Reserved |

In some instances, the all-zeros or all-ones state may be reserved to indicate an unknown state, which may allow the NC repeater 112 to power off without transmission or reception.

The size of a DCI Format X may be referred to as ‘S,’ may be calculated as follows: S=┌log₂(Bₜₒₜ+1)┐*((P*14)/Z. Assuming Z=2 symbols, B_tot=4 beams, and P=2 slots, DCI Format X 1204 may have a size, S, equal to 42 bits. The first 21 bits may indicate up to seven beam indicator indexes for a first slot, while the second 21 bits may indicate up to seven beam indicator indexes for a first slot.

In some embodiments, the NC repeater 112 may determine whether the indicated beams are to be used as transmit or receive beams based on a corresponding TDD UL-DL configuration. For example, if a TDD UL-DL configuration provides a subframe sequence of DDDUU; the NC repeater 112 may determine that the beams corresponding to the first three beam indexes provided in the DCI Format X are transmit beams, while the beams corresponding to the next two beam indexes provided in the DCI Format X are receive beams.

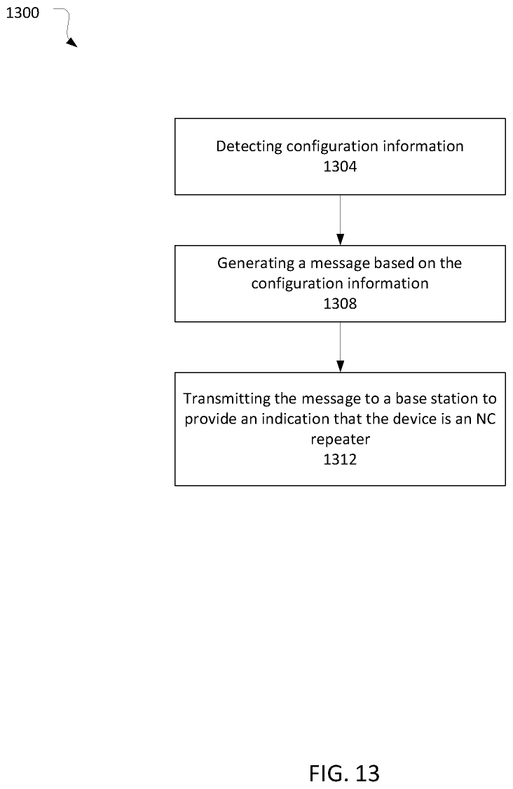

FIG. 13 may include an operation flow/algorithmic structure 1300 in accordance with some embodiments. The operation flow/algorithmic structure 1300 may be performed or implemented by an NC repeater such as, for example, NC repeater 112 or network device 1600; or components thereof, for example, baseband processor 1604A

The operation flow/algorithmic structure 1300 may include, at 1304, detecting configuration information. The configuration information may include device type information that indicates the operating device is an NC repeater.

The operation flow/algorithmic structure 1300 may further include, at 1308, generating a message based on the configuration information. In some embodiments, the message may be a Msg3 of a 4-step RACH procedure or a PUSCH in a MsgA of a 2-step RACH procedure. In other embodiments, the message may be a capability report message.

The operation flow/algorithmic structure 1300 may further include, at 1312, transmitting the message to a base station to provide an indication that the device is an NC repeater. In some embodiments, the indication may be provided by transmitting a preamble in a PRACH resource configured by a SIB message for NC repeater identification or by transmitting a preamble configured by the SIB message for NC repeater identification. In other embodiments, the indication may be provided by transmitting an LCID in a Msg3 or MsgB PUSCH. In still other embodiments, the indication may be provided by transmitting a device-type IE in a capability report message.

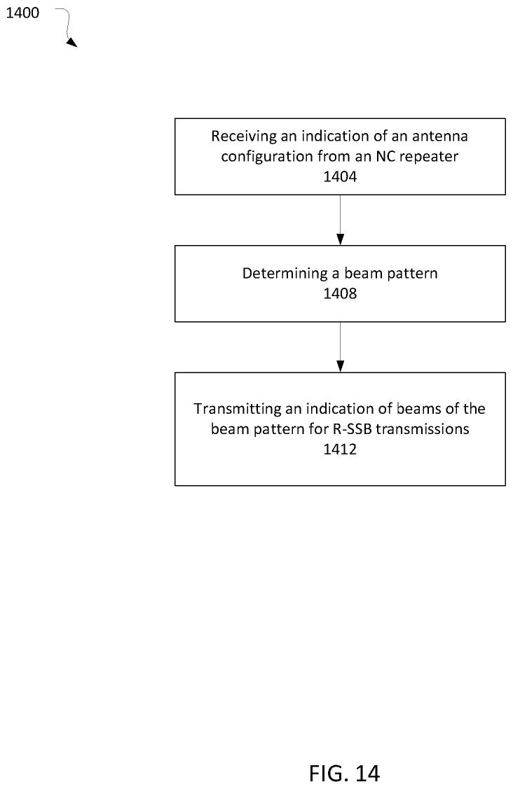

FIG. 14 may include an operation flow/algorithmic structure 1400 in accordance with some embodiments. The operation flow/algorithmic structure 1400 may be performed or implemented by a base station such as, for example, base station 108 or network device 1600; or components thereof, for example, baseband processor 1604A

The operation flow/algorithmic structure 1400 may include, at 1404, receiving an indication of an antenna configuration from an NC repeater. The indication of an antenna configuration may be provided by transmitting an index that references a configuration from a set of antenna configurations. The antenna configuration may include a number of antenna panels, a number of antenna elements in vertical/horizontal directions, and DFT oversampling in horizontal/vertical directions.

The operation flow/algorithmic structure 1400 may further include, at 1408, determining a beam pattern. The beam pattern may be determined based on the antenna configuration.

The operation flow/algorithmic structure 1400 may further include, at 1412, transmitting an indication of beams of the beam pattern for R-SSB transmissions. The indication may be transmitted by DCI, MAC, or RRC signaling.

In some embodiments, the beams may be indicated by transmitting a bitmap having a number of bits that corresponds to a number of beams in the beam pattern. In some embodiments, the beams may be indicated using a plurality of fields to identify a plurality of contiguous beams. For example, a first field may indicate a starting beam index; a second field may indicate a number of contiguous beams in a horizontal direction; and a third field may indicate a number of contiguous beams in a vertical direction. In another example, a first field may jointly indicate a starting beam index and a number of contiguous beams in a first direction (for example, horizontal or vertical); and a second field to indicate a number of contiguous beams in a second direction (for example, vertical or horizontal). In still another example, one or more fields may be used to indicate a corresponding one or more beam groups. Each of the beam groups may include an orthogonal DFT beam and one or more oversampled DFT beams associated with the orthogonal DFT beam.

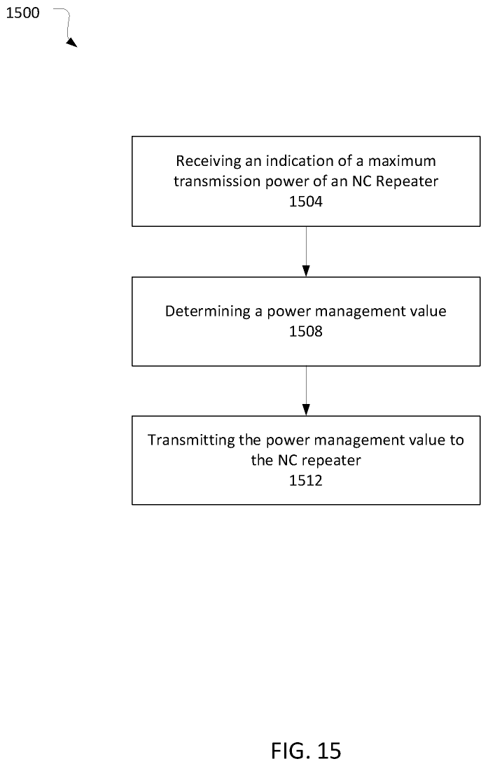

FIG. 15 may include an operation flow/algorithmic structure 1500 in accordance with some embodiments. The operation flow/algorithmic structure 1500 may be performed or implemented by a base station such as, for example, base station 108 or network device 1600; or components thereof, for example, baseband processor 1604A

The operation flow/algorithmic structure 1500 may include, at 1504, receiving an indication of a maximum transmission power of an NC repeater. The indication may be received directly from the NC repeater.

The operation flow/algorithmic structure 1500 may further include, at 1508, determining a power management value. In some embodiments, the power management value may be a transmission power of an SSB, which may be set equal to the maximum transmission power of the NC repeater. In some embodiments, the power management value may be a first PRACH target reception power for performing a RACH procedure with the NC repeater. The first PRACH target reception power may be set equal to a second PRACH target reception power for performing a Rach procedure directly with the base station minus a difference between a maximum power of the base station and the maximum transmit power of the NC repeater.

The operation flow/algorithmic structure 1500 may further include, at 1512, transmitting the power management value to the NC repeater. The power management value may be transmitted in a SIB, which the NC repeater forwards to one or more UEs connected with the NC repeater.

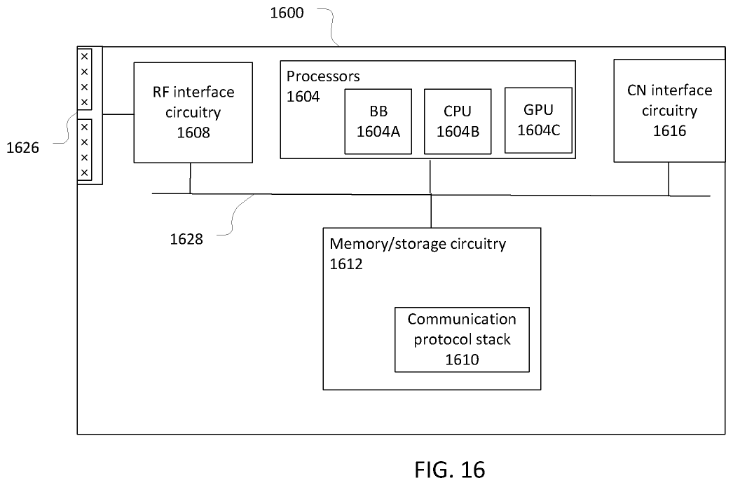

FIG. 16 illustrates a network device 1600 in accordance with some embodiments. The network device 1600 may be similar to and substantially interchangeable with base station 108 or NC repeater 112.

The network device 1600 may include processors 1604, RF interface circuitry 1608, memory/storage 1612, and CN interface circuitry 1616. The components of the network device 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the network device 1600. However, some of the components shown may be omitted, additional components may be present, and different arrangement of the components shown may occur in other implementations.

The components of the network device 1600 may be coupled with various other components over one or more interconnects 1628, which may represent any type of interface, input/output, bus (local, system, or expansion), transmission line, trace, or optical connection that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the network device 1600 to perform operations as described herein.

In some embodiments, the baseband processor circuitry 1604A may access a communication protocol stack 1610 in the memory/storage 1612 to communicate over a 3GPP compatible network. In general, the baseband processor circuitry 1604A may access the communication protocol stack 1610 to: perform user plane functions at a PHY layer, MAC layer, RLC layer, PDCP layer, and SDAP layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1608. In embodiments in which the network device 1600 is an NC repeater, the communication protocol stack 1610 may include fewer and lower layers as compared to a base station.

The baseband processor circuitry 1604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1612 may include one or more non-transitory, computer-readable media that includes instructions (for example, communication protocol stack 1610) that may be executed by one or more of the processors 1604 to cause the network device 1600 to perform various operations described herein. The memory/storage 1612 include any type of volatile or non-volatile memory that may be distributed throughout the network device 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and radio frequency front module (RFEM) that allows the network device 1600 to communicate with other devices over a radio access network. The RF interface circuitry 1608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1626 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1626.

In various embodiments, the RF interface circuitry 1608 may be configured to transmit/receive signals in a manner compatible with NR and sidelink access technologies.

The antenna 1626 may include antenna elements to convert electrical signals into radio waves to travel through the air and to convert received radio waves into electrical signals. The antenna elements may be arranged into one or more antenna panels. The antenna 1626 may have antenna panels that are omnidirectional, directional, or a combination thereof to enable beamforming and multiple input, multiple output communications. The antenna 1626 may include microstrip antennas, printed antennas fabricated on the surface of one or more printed circuit boards, patch antennas, or phased array antennas. The antenna 1626 may have one or more panels designed for specific frequency bands including bands in FR1 or FR2.

The CN interface circuitry 1616 may provide connectivity to a core network, for example, a 5th Generation Core network (5GC) using a 5GC-compatible network interface protocol such as carrier Ethernet protocols, or some other suitable protocol. Network connectivity may be provided to/from the network device 1600 via a fiber optic or wireless backhaul. The CN interface circuitry 1616 may include one or more dedicated processors or FPGAs to communicate using one or more of the aforementioned protocols. In some implementations, the CN interface circuitry 1616 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a device, the method comprising: detecting configuration information; generating a message based on the configuration information; and transmitting the message to a base station to provide an indication that the device is a network-controlled (NC) repeater.

Example 2 includes a method of example 1 or some other example herein, further comprising: receiving, from a base station, a system information block (SIB) message to configure a physical random access channel (PRACH) resource or preamble associated with a network-controlled (NC) repeater identification; and transmitting, to the base station, a preamble in the PRACH resource configured by the SIB message or the preamble configured by the SIB message as the message to provide the indication that the device is an NC repeater.

Example 3 includes the method of example 1 or some other example herein, wherein the message is a message 3 of a 4-step random access channel (RACH) procedure or a PUSCH in message A of a 2-step RACH procedure and includes a logical channel identifier (LCID) to provide the indication that the device is an NC repeater.

Example 4 includes the method of example 1 or some other example herein, wherein the message comprises a UE capability report message that includes a device-type information element (IE) to provide the indication that the device is an NC repeater.

Example 5 includes the method of example 1 or some other example herein, further comprising: transmitting, to the base station, a UE capability report message that is to indicate an antenna configuration of the device.

Example 6 includes a method of example 5 or some other example herein, wherein the antenna configuration comprises: a number of antenna panels on the device, a number of antenna elements in a horizontal direction per antenna panel, a number of antenna elements in a vertical direction per antenna panel, a discrete Fourier transform (DFT) oversampling in a horizontal direction per antenna panel, or a DFT oversampling in a vertical direction per antenna panel.

Example 7 includes the method of example 5 or some other example herein, wherein the UE capability report message comprises an antenna configuration index to indicate the antenna configuration of the device from a set of antenna configurations that is predefined for the device.

Example 8 includes the method of example 1 or some other example herein, further comprising: transmitting, to the base station, a UE capability report message that is to indicate a maximum transmission power or a power class of the device from a set of predefined power classes where each power class is associated with a corresponding maximum transmission power.

Example 9 includes a method of operating a base station, the method comprising: receiving an indication of an antenna configuration from a network-controlled (NC) repeater; determining a beam pattern of the NC repeater based on antenna configuration; providing, to the NC repeater, an indication of a plurality of beams of the beam pattern to use for transmitting synchronization signal physical broadcast channel (SSB) transmissions.

Example 10 includes the method of example 9 or some other example herein, wherein the indication of the plurality of beams comprises a bitmap having a number of bits that corresponds to a number of beams in the beam pattern.

Example 11 includes a method of example 9 or some other example herein, wherein the indication of the plurality of beams comprises a first field to indicate a starting beam index, a second field to indicate a number of contiguous beams in a horizontal direction, and a third field to indicate a number of contiguous beams in a vertical direction.

Example 12 includes a method of example 9 or some other example herein, wherein the indication of the plurality of beams comprises a first field to jointly indicate a starting beam index and a number of contiguous beams in a first direction, and a second field to indicate a number of contiguous beams in a second direction.

Example 13 includes the method of example 9 or some other example herein, wherein the indication of the plurality of beams comprises a field to indicate one or more beam groups, wherein individual beam groups of the one or more beam groups have one orthogonal discrete Fourier transform (DFT) beam and one or more oversampled DFT beams associated with the one orthogonal DFT beam.

Example 14 includes the method of example 9 or some other example herein, further comprising: providing the indication of the plurality of beams in downlink control information (DCI) signaling, media access control (MAC) signaling, or radio resource control (RRC) signaling.

Example 15 includes a method of operating a base station, the method comprising: receiving an indication of a maximum transmission power of a network-controlled (NC) repeater; determining a power management value based on the maximum transmission power of the NC repeater; and transmitting the power management value to the NC repeater in a system information block (SIB) transmission.

Example 16 includes the method of example 15 or some other example herein, wherein the power management value is a transmission power of a synchronization signal physical broadcast channel block (SSB) that is set equal to the maximum transmission power indicated by the NC repeater.

Example 17 includes the method of example 15 or some other example herein, wherein the power management value is a first physical random access channel (PRACH) target reception power for performing a random access channel (RACH) procedure with the NC repeater, the first PRACH target reception power is equal to a second PRACH target reception power for performing a RACH procedure directly with a base station minus a difference between a maximum transmit power of the base station and the maximum transmit power of the NC repeater.

Example 18 includes a method of operating a base station, the method comprising: generating repeater-synchronization signal physical broadcast channel block (R-SSB) configuration information, the R-SSB configuration information to include indications of an R-SSB periodicity and time-domain positions of a plurality of R-SSBs within an SSB burst; and transmitting the R-SSB configuration information to a network-controlled (NC) repeater.

Example 19 includes the method of example 18 or some other example herein, further comprising: transmitting the plurality of R-SSBs to the NC repeater with one transmit beam.

Example 20 includes the method of example 19 or some other example herein, wherein the plurality of R-SSBs is a first plurality and the method further comprises: transmitting a second plurality of synchronization signal physical broadcast channel blocks (SSBs) with a corresponding second plurality of transmit beams.

Example 21 includes a method of operating a network-controlled (NC) repeater, the method comprising: receiving, from a base station, random access channel (RACH) configuration information; transmitting a repeater-synchronization signal physical broadcast channel block (R-SSB) with a transmit beam; receiving, from a user equipment (UE), a first message of a RACH procedure in a RACH occasion (RO); and determining, based on the RACH configuration information and the RO, a beam to use for receiving the first message.

Example 22 includes the method of example 21 or some other example herein, wherein the RACH configuration information comprises a physical random access channel (PRACH) configuration index and the method further comprises: deriving, based on the PRACH configuration index, a random access channel occasion (RO) time domain location that corresponds to the R-SSB; receiving the first message in the RO time domain location; and determining the beam is the transmit beam or a receive beam that corresponds to the transmit beam based on said receiving the first message in the RO time-domain location that corresponds to the R-SSB.

Example 23 includes the method of example 21 or some other example herein, wherein the RACH configuration information includes parameters to indicate time-domain location of PRACH resources, the parameters to include a PRACH configuration index, a periodicity, a subframe index, a starting symbol index, a number of PRACH slots within a subframe, or a number of time-domain ROs within a PRACH slot, a PRACH duration, or a PRACH format.

Example 24 includes a method of example 23 or some other example herein, further comprising: determining a plurality of random access channel occasions (ROs) based on the time-domain location of PRACH resources: determining an order of the plurality of ROs; and associating the plurality of ROs with a corresponding plurality of beams indicated for R-SSB sweeping based on the order.

Example 25 includes a method of example 21 or some other example herein, wherein the beam is a first beam and the method further comprises: receiving, from the base station, a physical downlink control channel (PDCCH) with downlink control information (DCI) to indicate a beam to use for at least a second message of the RACH procedure.

Example 26 includes the method of example 25 or some other example herein, further comprising: receiving, from the base station, a time-domain beam pattern configuration having a beam-indication periodicity or a beam duration; and configuring the beam based on the time-domain beam pattern configuration and the DCI.

Example 27 includes the method of example 26 or some other example herein, wherein the DCI comprises a set of beam indicator fields, wherein individual fields of the set are to indicate a respective beam for a corresponding beam duration within a beam-indication periodicity.

Example 28 includes the method of example 27 or some other example herein, wherein a first beam indicator field of the set of beam indicator fields includes all zeros or all ones to indicate an unknown state and the method further comprises: powering off based on detection of the unknown state. Example 29 may include an apparatus comprising means to perform one or more elements of a method described in or related to any of examples 1-28, or any other method or process described herein.

Example 30 may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Example 31 may include an apparatus comprising logic, modules, or circuitry to perform one or more elements of a method described in or related to any of examples 1-28, or any other method or process described herein.

Example 32 may include a method, technique, or process as described in or related to any of examples 1-28, or portions or parts thereof.

Example 33 may include an apparatus comprising: one or more processors and one or more computer-readable media comprising instructions that, when executed by the one or more processors, cause the one or more processors to perform the method, techniques, or process as described in or related to any of examples 1-28, or portions thereof.

Example 34 may include a signal as described in or related to any of examples 1-28, or portions or parts thereof.

Example 35 may include a datagram, information element, packet, frame, segment, PDU, or message as described in or related to any of examples 1-28, or portions or parts thereof, or otherwise described in the present disclosure.

Example 36 may include a signal encoded with data as described in or related to any of examples 1-28, or portions or parts thereof, or otherwise described in the present disclosure.

Example 37 may include a signal encoded with a datagram, IE, packet, frame, segment, PDU, or message as described in or related to any of examples 1-28, or portions or parts thereof, or otherwise described in the present disclosure.

Example 38 may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Example 39 may include a computer program comprising instructions, wherein execution of the program by a processing element is to cause the processing element to carry out the method, techniques, or process as described in or related to any of examples 1-28, or portions thereof.

Example 40 may include a signal in a wireless network as shown and described herein.

Example 41 may include a method of communicating in a wireless network as shown and described herein.

Example 42 may include a system for providing wireless communication as shown and described herein.

Example 43 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
detecting configuration information; and
generating, for transmission to a base station, a message based on the configuration information to provide an indication that a device is a network-controlled (NC) repeater.

22. The method of claim 21, further comprising:
receiving, from the base station, a system information block (SIB) message to configure a physical random access channel (PRACH) resource or preamble associated with an NC repeater identification.

23. The method of claim 22, further comprising:
generating, for transmission to the base station, a preamble in the PRACH resource configured by the SIB message or the preamble configured by the SIB message as the message to provide the indication that the device is an NC repeater.

24. The method of claim 21, wherein the message is a message 3 of a 4-step random access channel (RACH) procedure or a PUSCH in message A of a 2-step RACH procedure and includes a logical channel identifier (LCID) to provide the indication that the device is an NC repeater.

25. The method of claim 21, wherein the message comprises a user equipment (UE) capability report message that includes a device-type information element (IE) to provide the indication that the device is an NC repeater.

26. The method of claim 21, further comprising:
generating, for transmission to the base station, a UE capability report message that is to indicate an antenna configuration of the device.

27. The method of claim 26, wherein the antenna configuration comprises: a number of antenna panels on the device, a number of antenna elements in a horizontal direction per antenna panel, or a number of antenna elements in a vertical direction per antenna panel.

28. The method of claim 26, wherein the antenna configuration comprises: a discrete Fourier transform (DFT) oversampling in a horizontal direction per antenna panel or a DFT oversampling in a vertical direction per antenna panel.

29. The method of claim 26, wherein the UE capability report message comprises an antenna configuration index to indicate the antenna configuration of the device from a set of antenna configurations that is predefined for the device.

30. The method of claim 21, further comprising:
generating, for transmission to the base station, a UE capability report message that is to indicate a maximum transmission power.

31. The method of claim 21, further comprising:
generating, for transmission to the base station, a UE capability report message that is to indicate a power class of the device from a set of predefined power classes where each power class is associated with a corresponding maximum transmission power.

32. An apparatus comprising:
processor circuitry to:
receiving an indication of an antenna configuration from a network-controlled (NC) repeater;
determining a beam pattern of the NC repeater based on antenna configuration; and
providing, to the NC repeater, an indication of a plurality of beams of the beam pattern to use for transmitting synchronization signal physical broadcast channel (SSB) transmissions; and
interface circuitry coupled with the processor circuitry to enable communication.

33. The apparatus of claim 32, wherein the indication of the plurality of beams comprises a bitmap having a number of bits that corresponds to a number of beams in the beam pattern.

34. The apparatus of claim 32, wherein the indication of the plurality of beams comprises a first field to indicate a starting beam index, a second field to indicate a number of contiguous beams in a horizontal direction, and a third field to indicate a number of contiguous beams in a vertical direction.

35. The apparatus of claim 32, wherein the indication of the plurality of beams comprises a first field to jointly indicate a starting beam index and a number of contiguous beams in a first direction, and a second field to indicate a number of contiguous beams in a second direction.

36. The apparatus of claim 32, wherein the indication of the plurality of beams comprises a field to indicate one or more beam groups, wherein individual beam groups of the one or more beam groups have one orthogonal discrete Fourier transform (DFT) beam and one or more oversampled DFT beams associated with the one orthogonal DFT beam.

37. The apparatus of claim 32, wherein the processor circuitry is further to:
provide the indication of the plurality of beams in downlink control information (DCI) signaling, media access control (MAC) signaling, or radio resource control (RRC) signaling.

38. One or more non-transitory, computer-readable media having instructions that, when executed, cause processor circuitry to:
receive an indication of a maximum transmission power of a network-controlled (NC) repeater;
determine a power management value based on the maximum transmission power of the NC repeater; and
generate, for transmission to the NC repeater, a system information block (SIB) having the power management value.

39. The one or more non-transitory, computer-readable media of claim 38, wherein the power management value is a transmission power of a synchronization signal physical broadcast channel block (SSB) that is set equal to the maximum transmission power indicated by the NC repeater.

40. The one or more non-transitory, computer-readable media of claim 38 or 36, wherein the power management value is a first physical random access channel (PRACH) target reception power for performing a random access channel (RACH) procedure with the NC repeater, the first PRACH target reception power is equal to a second PRACH target reception power for performing a RACH procedure directly with a base station minus a difference between a maximum transmit power of the base station and the maximum transmit power of the NC repeater.
